(19) United States
(12) Patent Application Publication
(10) Pub. No.: US 2016/0163009 A1
(43) Pub. Date: Jun. 9, 2016

(54) METHOD AND SYSTEM FOR EDUCATIONAL NETWORKING AND SERVICES

(71) Applicants: Mahdy Saedy, Holmdel, NJ (US); Amir Rajaee, San Diego, CA (US); Mo Jamshidi, San Antonio, TX (US); Nima Jamshidi, Albuquerque, NM (US)

(72) Inventors: Mahdy Saedy, Holmdel, NJ (US); Amir Rajaee, San Diego, CA (US); Mo Jamshidi, San Antonio, TX (US); Nima Jamshidi, Albuquerque, NM (US)

(21) Appl. No.: 15/007,256

(22) Filed: Jan. 27, 2016

Related U.S. Application Data
(63) Continuation-in-part of application No. 13/944,057, filed on Jul. 17, 2013.
(60) Provisional application No. 61/741,563, filed on Jul. 24, 2012.

(51) Int. Cl. G06Q 50/20; H04L 29/08; G06Q 50/00

(52) U.S. Cl. CPC G06Q 50/2053; G06Q 50/01; H04L 67/306

(57) ABSTRACT

A system, method and computer program product for educational networking, including a computer server coupled to a communications network and configured to provide educational networking and services to users on client devices coupled to the computer server over the communications network, including automating application generation and processing at educational schools for the users on the client devices; searching and displaying on the client devices professors at the schools, schools to apply to, funding resources for attending the schools, and laboratories at the schools; and creating and displaying on the client devices school application portfolios, modifying school application portfolios, and generating and processing applications to selected schools.

### CROSS REFERENCE TO RELATED APPLICATIONS

The present invention is a CIP of another application, Ser. No. 13/944,057, filed Jul. 17, 2013, with the same assignee, which takes the priority to U.S. Provisional Patent Application Ser. No. 61/741,563, of Mandy Saedy et al., filed on Jul. 24, 2012. The entire disclosures of above applications are incorporated herein by reference.

### BACKGROUND OF THE INVENTION

1. Field of the Invention

The present invention generally relates to online educational networking systems and methods with corresponding services, and more particularly to methods and systems for providing a complete social networking for education including academic and non-academic sectors and services, including admission services, application management, school search, profile and resume management, news feed and announcement, services, and the like.

2. Discussion of the Background

In recent years, methods and systems for social networking and staying connected have experienced a dramatic growth. However, one of the areas that is still in need of social networking is education, and the like. Sharing the educational experience and receiving efficient services in admission process for students, professors and even universities is a big requirement. Efficient communication and connection among students, professors and researches throughout the educational/academic life is extremely advantageous. Each semester, millions of students need to search schools, funding resources, open positions, and prospective advisors to take their next steps in their career. There are few online communities that have looked into academic community to help the users with sharing their success stories. Other providers have looked into research papers and help the users share research papers, and the like. Others have looked into online education and content generation. However, existing providers today typically are simple websites that provide one or two services without presenting a complete social network that can connect users, and the like.

### SUMMARY OF THE INVENTION

Therefore, there is a need for a method and system that addresses the above and other problems. The above and other problems are addressed by the illustrative embodiments of the present invention, which provide a complete academic/educational social network system and method that connects millions of students, professors, researchers, and the like, around the world by providing services, resources, and the like, that walk students through their education, assist professors, researchers, and the like, in their academic career, and the like. Advantageously, users, including students, professors, education/academic related users, such as alumni, researches, anyone that is directly or indirectly connected to the education/academia, and the like, can benefit from the pre-admission to post-graduation services, and the like, of the illustrative system and method.

Accordingly, in illustrative aspects of the present invention there is provided a system, method, and computer program product for educational networking, including a computer server coupled to a communications network and configured to provide educational networking and services to users on client devices coupled to the computer server (cloud) over the communications network, including automating application generation and processing educational schools for the users on the client devices; searching and displaying on the client devices professors at the schools, schools to apply to, funding resources for attending the schools, and laboratories at the schools; and creating and displaying on the client devices school application portfolios, modifying school application portfolios, and generating and processing applications to selected schools.

The educational networking and services configured for searching and displaying on the client devices professors and advisors at selected schools (and chance of admission); and the educational networking and services configured for communicating and networking with professors and advisors at selected schools on the client devices, maintaining and displaying on the client devices records regarding potential schools, and determining and displaying on the client devices probabilities of admission of the users at selected schools.

The educational networking and services configured for creating and displaying on the client devices standardized profile pages for the users. Users can also have their own public profile link to share with their peers. Users can upload files and share it on their public profile too.

The educational networking and services configured for creating and displaying on the client devices standardized resumes based on the standardized profile pages, editing the generated resumes, and tracking revisions in the generated resumes.

The educational networking and services are configured for providing social networking services including creating and displaying on the client devices social networks and related services for the users.

The educational networking and services configured for generating, streaming via a global RSS feed and displaying on the client devices academic and educational related news and updates; the educational networking and services configured for determining, processing and displaying on the client devices open businesses and government positions for the users; and the educational networking and services configured for determining, processing and displaying on the client devices projects and taskforces for businesses and government projects to be serviced by the users.

The educational networking and services configured to allow users to create and edit their profile with details, including but not limited to basic information, publications, school information, biography, research interests, education, skills, courses they have taken and etc.

The educational networking and services configured to let users search schools and browse their detail such as faculty enrolment, ranking, information about admission process and etc.

The educational networking and services configured to help users create, edit, and delete notes in their profile.

The educational networking and services configured to help users search and connect with other students, professors, and in general, all users. When a user is in one's connection, his or her information is available to this user, and they can un-follow them at any time.

The educational networking and services configured to create and print out users' resume based on the information they provide to complete their profile. Users will not have to manually create resumes since their most up-to-date information is reflected to their resume as they make changes to their profile.

The educational networking and services configured to let users to upload any document they want, and share it on their public profile. This service is ideal for users who want to publish a document or any material on their profile for public use.

The educational networking and services configured to create a public and global link for users to share it on their other social media, web content, resumes, and etc. Public link helps users share general documents with their audience for example at a conference or class. Users' general information can be found on public profile such as biography.

The educational networking and services configured to provide a full document center where users can manage their files and documents. Users can have full functionality such as uploading files, creating, deleting, and organizing their file in their own document center.

The educational networking and services configured to let users search other users including millions of professors and researchers based on their basic information as well as extended search such as grant (financial support) availability. This service will help students narrow down their search finding the right professor/advisor, and on the other hand, helps professors and researchers find their peer so efficiently.

The educational networking and services configured to be able to exploit the latest technologies in data mining and post processing using Big Data techniques in order to handle large amount of unstructured data with notable velocity (the frequency with which data changes).

The educational networking and services configured to be able to use cloud infrastructure mainly, but not in strict sense in form of IaaS (Infrastructure as a Service) and PaaS (Platform as a Service). Providers such as Rackspace provide a good affordable solution in this field. With this, the educational networking and services launches its services on cloud in order to exploit benefits of cloud such as elasticity, scalability, affordability, and reliability.

Still other aspects, features, and advantages of the present invention are readily apparent from the following detailed description, by illustrating a number of illustrative embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which;

FIG. 1 is an illustrative login and sign up process for a method and system for educational networking and services;

FIG. 2 is an illustrative search service and process wherein a user starts with querying a database by keying in a name, email address, school or laboratory;

FIG. 3 is an illustrative connection management service and process so that contacts can be added or removed from a contact list;

FIG. 4 is an illustrative service and process for viewing, creating, and editing personal notes;

FIG. 5 is an illustrative class/course management service and process, wherein a user can view, add, modify, and delete classes on a profile of a user;

FIG. 6 is an illustrative profile management service and process that allows a user to create, update, and generate a resume;

FIG. 7 is an illustrative admission service and process including student admission portfolio management.

FIG. 8 is an illustrative admission service and process including student admission portfolio management.

FIG. 9 is an illustrative system including a security solution for the method and system for educational networking and services of FIGS. 1-8.

FIG. 10 is an illustrative backend data processing system that generates a major part of data sources for educational and academic networking services and users consumption. In 1003, multiple JAR files are triggered through crop jon located in a crontab file in UNIX box.

FIG. 11 is an illustrative cloud infrastructure that enables the educational and academic networking to benefit from elasticity, scalability, affordability, and reliability provided buy cloud. Three layers of service provided by cloud are as 1100, 1101, 1102—IaaS (Infrastructure as a Service) and PaaS (Platform as a Service), respectively.

FIG. 12 is an illustrative cloud infrastructure that enables the educational and academic networking to periodically monitor and maintain the database. The network admin launches maintenance script through 1201.

### DETAILED DESCRIPTION OF THE PREFERRED EMBODIMENTS

The present invention includes the recognition of shortcomings related to services in the academic/education field, for example, including (1) lack of a global and efficient academic/educational networking system that connects millions of students, professors, and researchers around the world; (2) lack of unified coordination and efficiency in professor-student/researcher communications during admission process; (3) lack of central and systematic communication among professors to track and evaluate prospective student applicants; (4) lack of a global and unified admission management and unified application processing service for students, (5) lack of a system for reducing and managing massive number of random emails received from student and applicants that need to be processed and responded to; (6) lack of an organized and unified recommendation letter issuance system; (7) lack of a global and unified profile and resume system that helps the academic/educational community create and manage resumes; (8) lack of a global, lightweight, efficient, and unified course management system; (9) lack of a centralized and global storage space and document management portal for academic/education community; and (10) lack of a unified profile page for academic/educational community; (11) existing systems and methods merely providing low quality and inefficient web pages for many professors with updating problems that leads to lack of visibility and searchability; (12) lack of a system for tracking progress of researchers and managing of laboratories by professors; (13) lack of a unified profile page for visibility of laboratories in industry; (14) lack of a unified news feed and announcement system for educational/academic news, updates, and announcements; (15) lack of a secure and dependable conference hosting system meant for the whole academic/educational community.

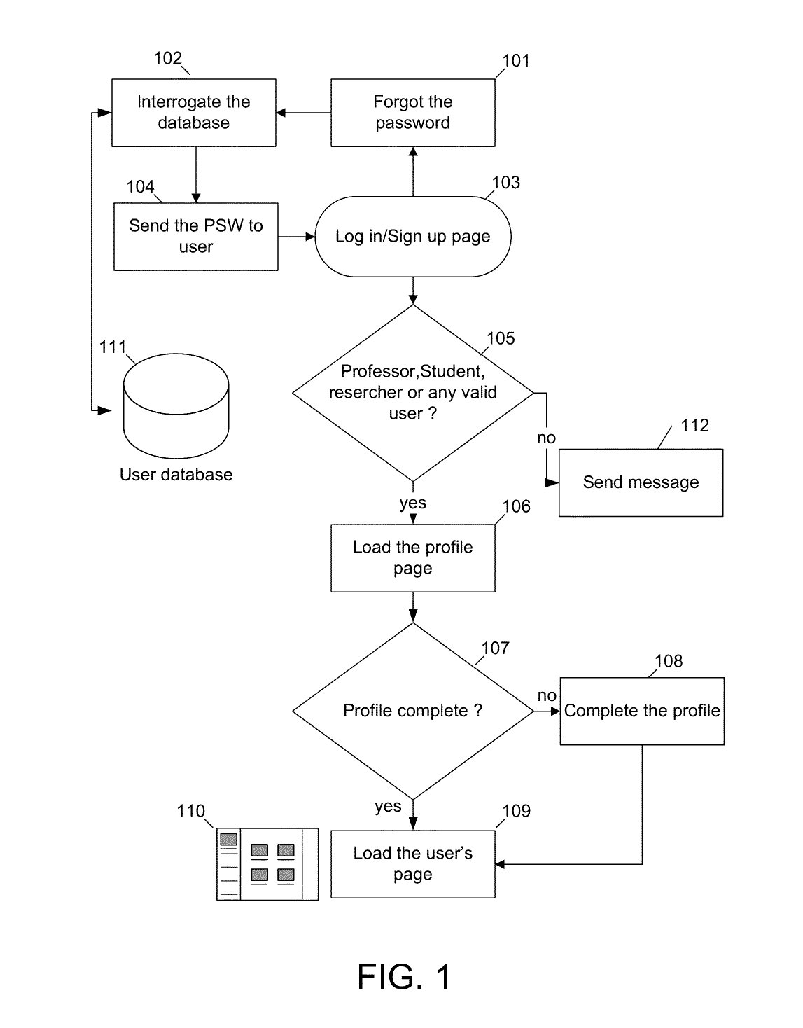

Referring now to the drawings, wherein like referring numerical designate identical or corresponding parts throughout the several views, and more particularly to FIG. 1, thereof there is illustrated a login and sign up process for a method and system for educational networking and services. In FIG. 1, the registration and login process, for new users, can include various options for students, professors or education/academic related users (e.g., alumni, researches and anyone that is directly or indirectly connected to the education/academia). Advantageously, depending on type of the user, different profile pages can be provided for the user.

The data entered at sign up time can be added to a database 111 and considered as the initial information employed for granting access to the user and reaching him/her through a provided search engine. Additional information can be completed by the user and consequently added to the database 111. The user enters a user ID and password to enter the educational networking and services website. In case the user doesn't have access (or doesn't remember) to the password, the user can chose to receive a temporary password via email so to be able to access the account of the user. The password can then be changed by the user at any convenient time.

Accordingly, the process starts with step 103. Step 101 checks if the user has forgotten the password. Then step 102 interrogates the user database 111 to retrieve the password and sends it to the user in step 104. Then the user can login in step 103. A sign up menu provided in step 103 allows different types of users to enter their information. After determining the type of user at step 105 or sending an appropriate message at step 112, the loading of the user profile in performed at step 106, and depending on how complete the profile is as determined at step 107, the user can be redirected to step 108 to complete the user profile, and/or to step 108 to load the profile user page 110 of the user.

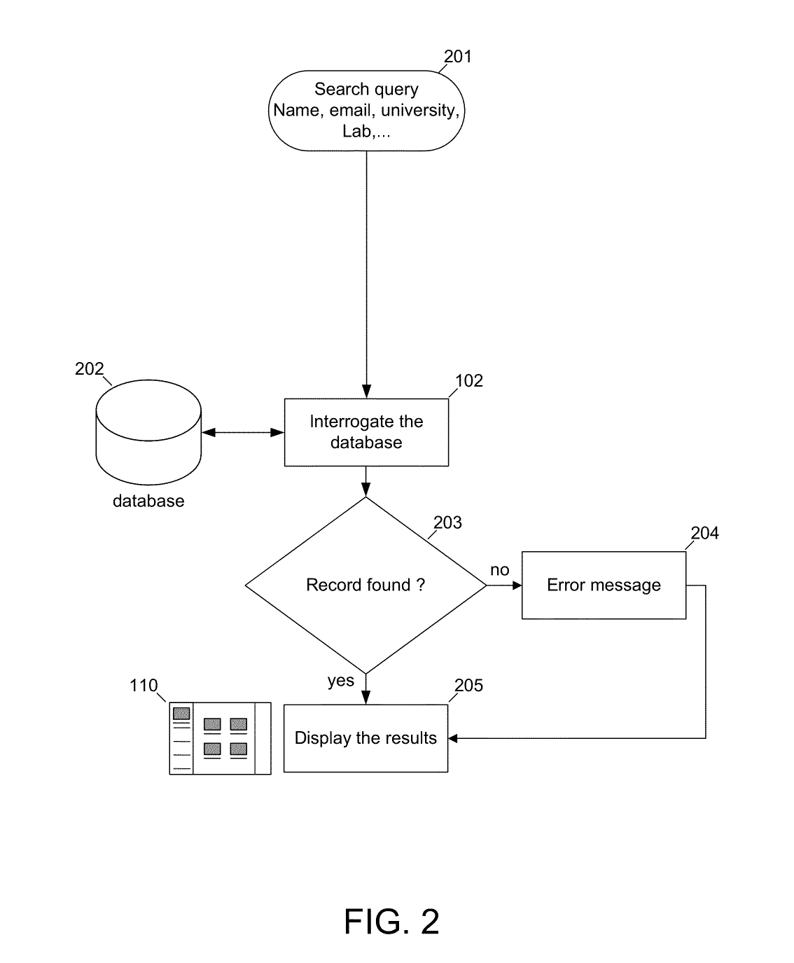

FIG. 2 is an illustrative search service and process, wherein a user starts with querying a database by keying in a name, email address, school or laboratory. In FIG. 2, the search service provides information about users of interest. A database 202 provides various records, files, and the like, to makes the search service possible. The search service provides efficient communication between students, professors, researchers, and other users. For example, in admission process, prospective students can find information professors, such as university, fields of study, publications, email addresses, and the like, to see if credentials of a professor matches interests of the user. The user also can contact a professor to figure out if the professor has any opening positions, and the like.

Accordingly, the user can type a name, email address, school, laboratory, and the like, in step 201 so that step 102 can look up in the database in 202 for any records and the like, checked at step 203 for availability of the corresponding results. If the entity, information, and the like, of interest is found the results are displayed at step 205 on the user page 110, otherwise step 204 displays an error message, and the like.

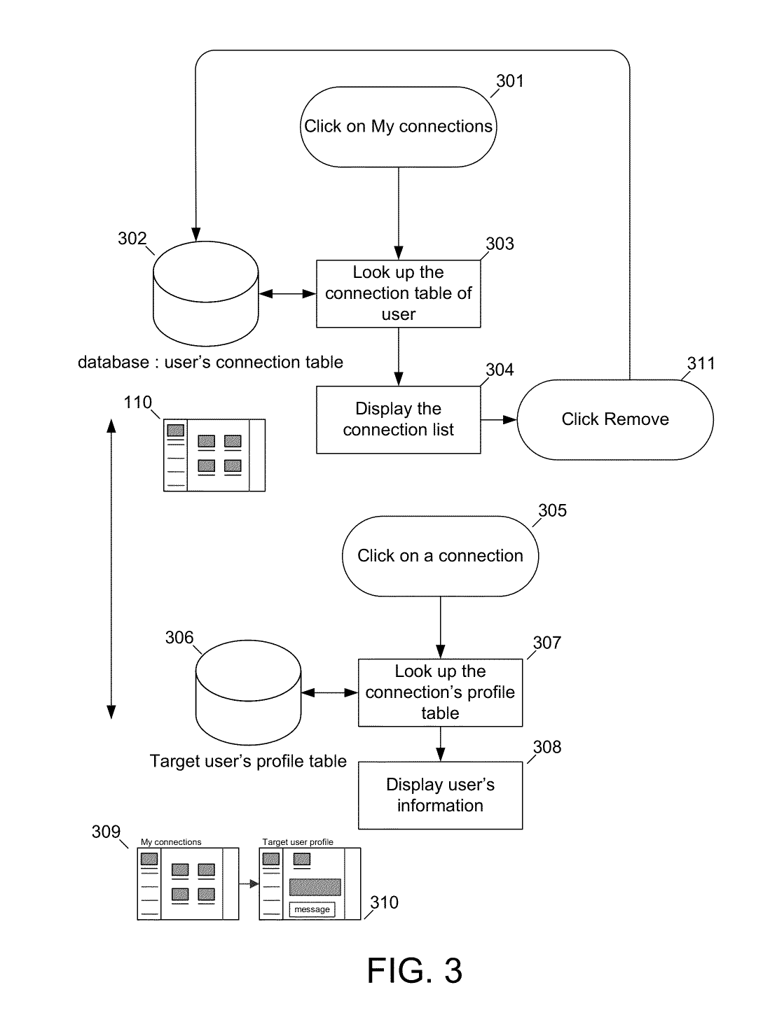

FIG. 3 is an illustrative connection management service and process so that contacts can be added or removed from a contact list. In FIG. 3, the connection management and networking service allows a user to add a person searched to the contacts of the user. The user can remove anyone on their contacts if they decide to do so. Users are able to see all of their contacts in a list on the user page 110, and can see the information for the contacts by clicking on the contact. Messaging, live conferencing, commenting, rating, recommending, and the like, services can be provided for each of the contacts. The people on the contact list can be categorized into current students, current professors, prospective student/professor, peers, classmates, colleagues, and the like.

Accordingly, the user can click on a “My connections” page in step 301, and step 303 looks up the corresponding information on the database 302, which is provides a connection table for the user. Then step 304 can display a picture, name, other information, and the like, about the users connected to the logged in user on the user page 110. The user can decide to remove a person from the contact list step 311, which updates the database 302. If the user decides to review specific information for a contact, the user can click on a specific user in step 305 so that step 307 can retrieve information from the database 306, which includes the target profile table 310 for the contact from the “My Connections” page 309.

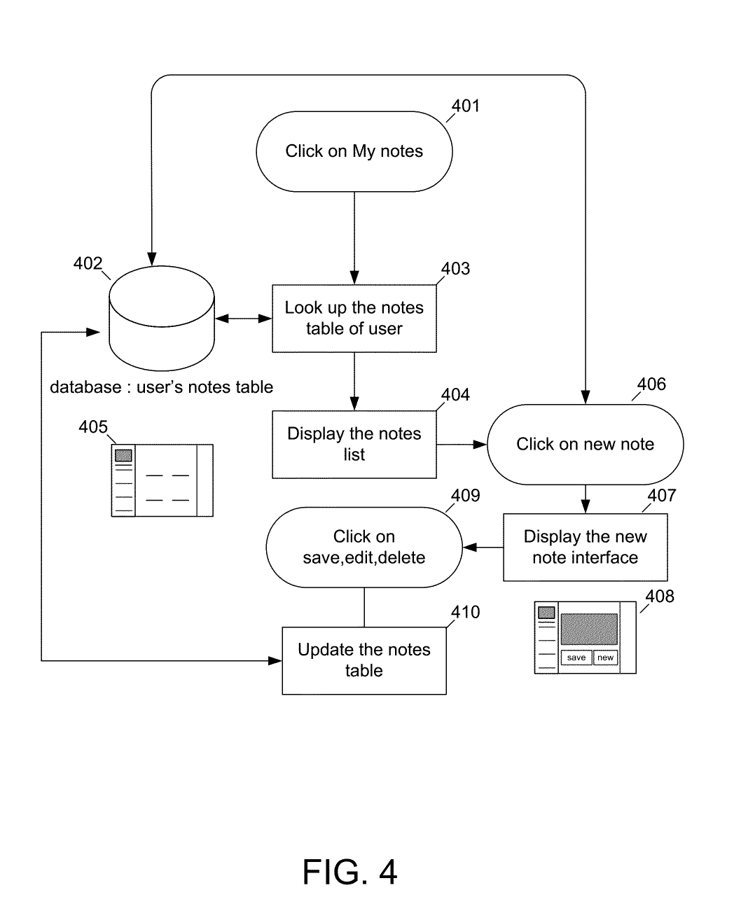

FIG. 4 is an illustrative service and process for viewing, creating, and editing personal notes. In FIG. 4, the personal notes service provides users with a capability to create, edit, manage, and the like, notes of a user and benefit from a note organizer. The notes that created, edited, and the like, stay in a database 402 for unlimited time, unless the user deletes the notes. The notes can be shared with contacts as well.

Accordingly, the user starts by clicking on a “My notes” link in step 401. Step 403 looks up a notes table 405 of the user in the database 402. Step 404 displays the existing notes 405 to the user. By clicking on a “New note” link in step 406, the database 402 gets updated, and step 407 displays a new note interface 408. Step 409 lets the user save, edit or delete the note, and step 410 updates the database 402.

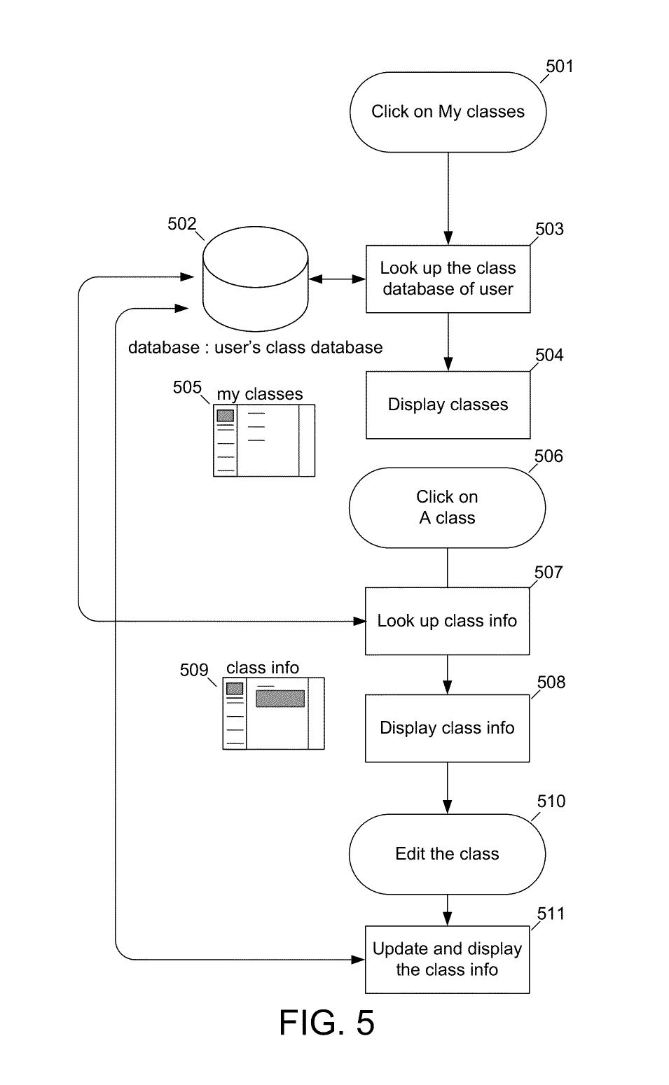

FIG. 5 is an illustrative class/course management service and process, wherein a user can view, add, modify, and delete classes on a profile of a user. In FIG. 5, the classes/course management service allows a user, such as a professor, and the like, to easily manage progress, grades, homework, and the like for students. Also, the professor is able to upload lectures, announcement, and the like. The files can be selected or ported from the My Documents section. The files can be shared so that other colleagues can comment on the files. The latest revisions are stored in a database 502. Advantageously, multiple revisions can be active due to conflict handling. In addition, a teaching assistant (TA) connection with students and the professor can be easily made. Furthermore, a forum for students to have better communication with each other can be provided. The extra time tutoring can be coordinated here too. The user can view, add, modify, or delete classes in the profile of the user.

Accordingly, by clicking on a “My classes” link in step 501, step 503 interrogates the database 502 to retrieve class, course, and the like, information on a class/course info page 505, and allows the user to view such information in step 504. If the user clicks on a specific course displayed at step 506, the user is able to see the information 509 about the course, wherein step 507 looks up the class table in the class database 502, and step 508 displays the class/course information 509. In step 510, a user can edit the class information 509, and step 511 can update the database 502 accordingly.

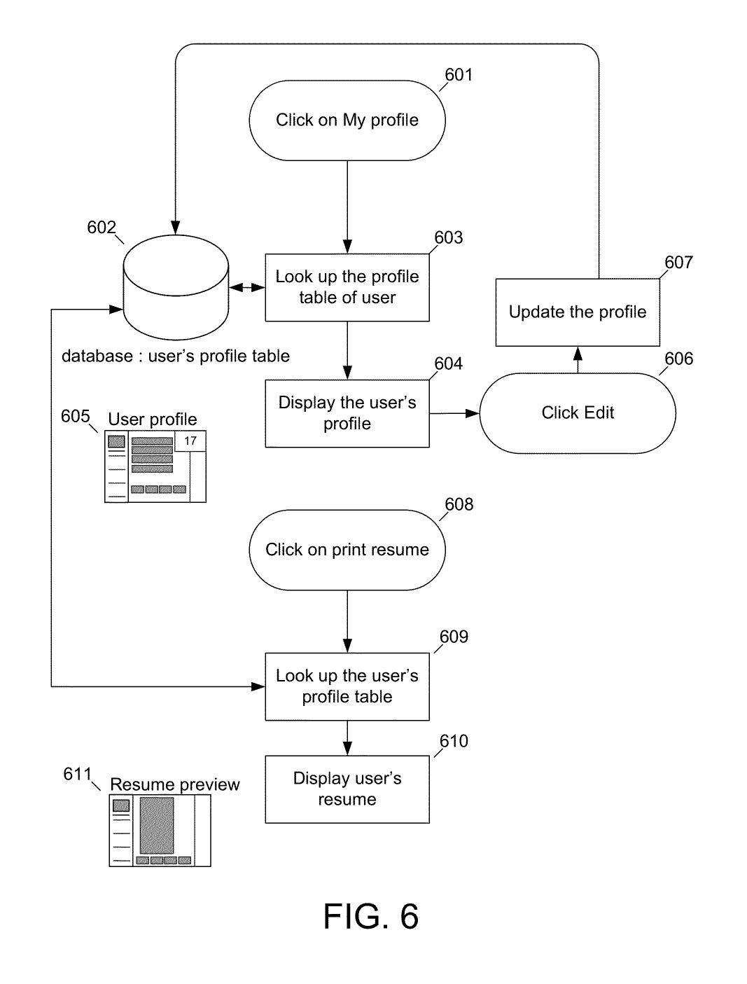

FIG. 6 is an illustrative profile management service and process that allows a user to create, update, and generate a resume. In FIG. 6, the profile management and resume generation service allows a user to create, edit, preview, print, share, upload, download, generally manage, and the like, a resume of the user. The latest revision of a resume of a user is maintained in a database 602 along with older revisions, and the like. The resume of the user can be automatically updated and printed in a unified format, advantageously, standardizing formats for academic resumes so that everyone can easily find needed information, and saving time for users to make such a standard resume. The user can just complete their profile, and then their resume can be created automatically. Advantageously, a user can create, update, and generate their profile that is then the source of the resume.

Accordingly, the service starts by clicking on a “My profile” link in step 601. Then, step 603 looks up the profile of the user to retrieve data for step 604 to display the profile of the user. It is possible to edit a current profile by clicking on an “Edit profile” link in step 606. Step 607 then updates the database 602, and displays the updated profile 605. If the user wants to preview their resume, the user clicks on a “print resume” button in step 608, and step 609 looks up the database 602 to convert the latest information from the profile of the user, for example, to a pdf file 611, and the like, in step 610, and which can be viewed and/or downloaded to a device of the user.

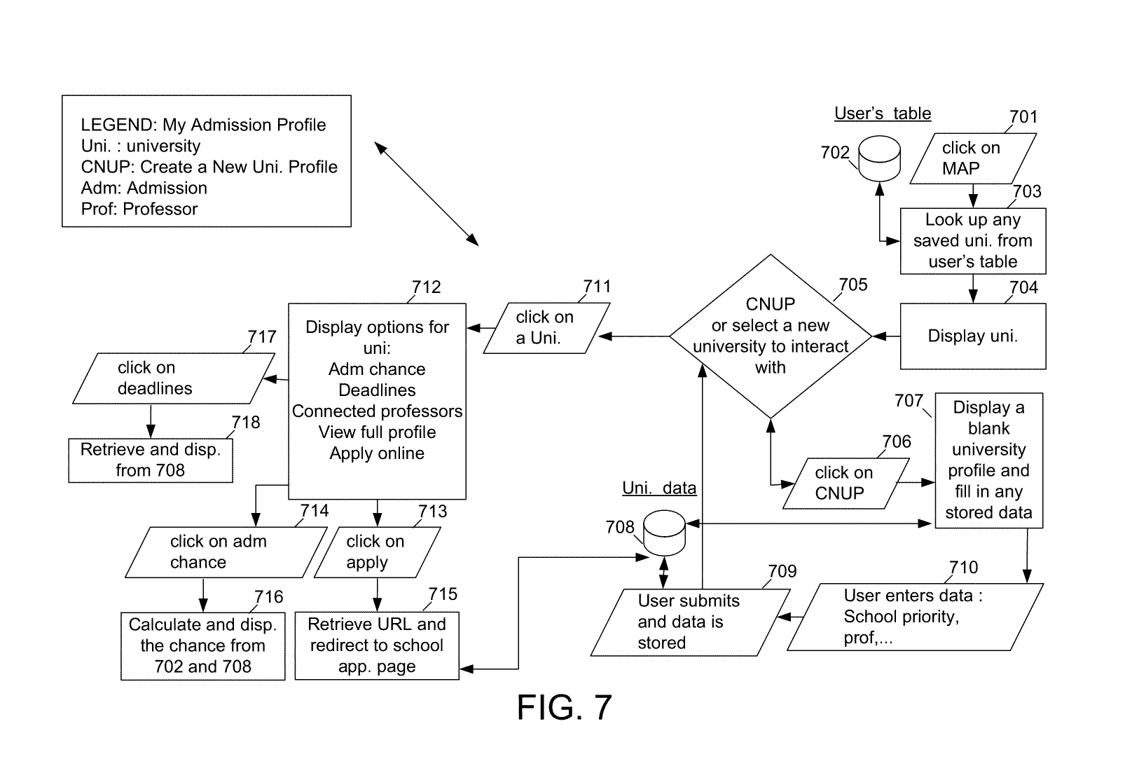

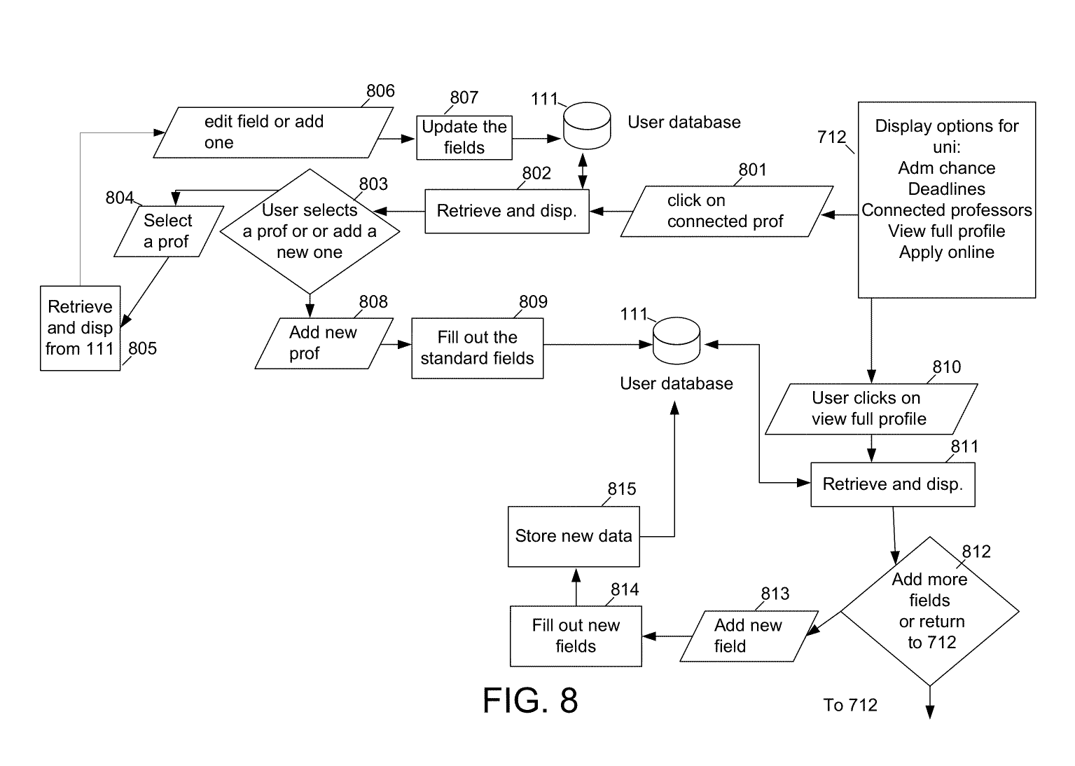

FIGS. 7-8 are an illustrative admission service and process including student admission portfolio management. In FIGS. 7-8, using the application management service, students can create a full application portfolio, for example, including, schools, programs, basically everything they want to apply for, and the like. Students from around the world can benefit from a unified and efficient application management system (AMS) that allows them to modify it based on their records, and which provides a close estimate as to their chance of getting admitted, for example, in percentages, and the like, to a specific program, thus saving time and money during the application process. The databases employed helps the users search for schools, sort their AMS portfolio, keep the track of their admissions, and the like. Each student can have multiple AMS portfolios, can share their portfolios, and can allow peers to provide modifications, comments, and the like.

Accordingly, a student starts by clicking on a “My Application Profile” link in step 701. Step 703 looks up the application profile table of the user in step 702, and step 704 displays the universities of interest to the user. In step 705, the user either creates a new university profile or works on an existing university profile. If user clicks on a specific university in step 711, then step 712 displays available information for that specific school, such as chance of getting admitted, deadlines, and the like. From step 712, the user can select specific information to be looked up from a database 708, and step 712 displays such information.

For example, by clicking on deadlines in steps 717, and 718 retrieve and display such information from the database 708. If user clicks on admission chances in step 714, step 716 calculates the chances for admission based on the information in the databases 702 and 708, and displays the chances for admission to the user.

The user can also choose to apply to a selected university in step 713, wherein step 715 retrieves, for example, a URL for the selected university and redirects the user to an application page for the selected school using information from the database 708. The user can click on a “CNUP” link in step 706 to create a new university profile, wherein step 707 displays a blank university the user and/or the system can fill in with relevant data. Step 710 lets the user enter data and criteria for schools, other factors, and the like. Step 709 submits the data, and updates the database 708.

If user clicks on a “connected professor” link in step 801, then step 802 retrieves and displays the relevant information from database 111. In step 803, the user can either select a professor or add a new one. If user selects a professor in step 804, then step 805 displays the corresponding information using the database 111. In step 806, the user can decide to either edit existing fields and/or add new fields regarding the professor. In either case, step 807 updates the database 111 accordingly. If user wants to add a new professor in step 808, then step 809 displays a standard field set, and lets the user fill out the fields. The new set of information filled out in step 809 is then stored in the database 111. If the user wants to see the full profile in step 810, then step 811 provides such information using the database 111. In step 812, the user can either decide to add more fields or return to step 712. If user decides to add more fields in step 813, step 814 provides a new blank field and lets the user fill it out, and then step 815 stores the new data in the database 111.

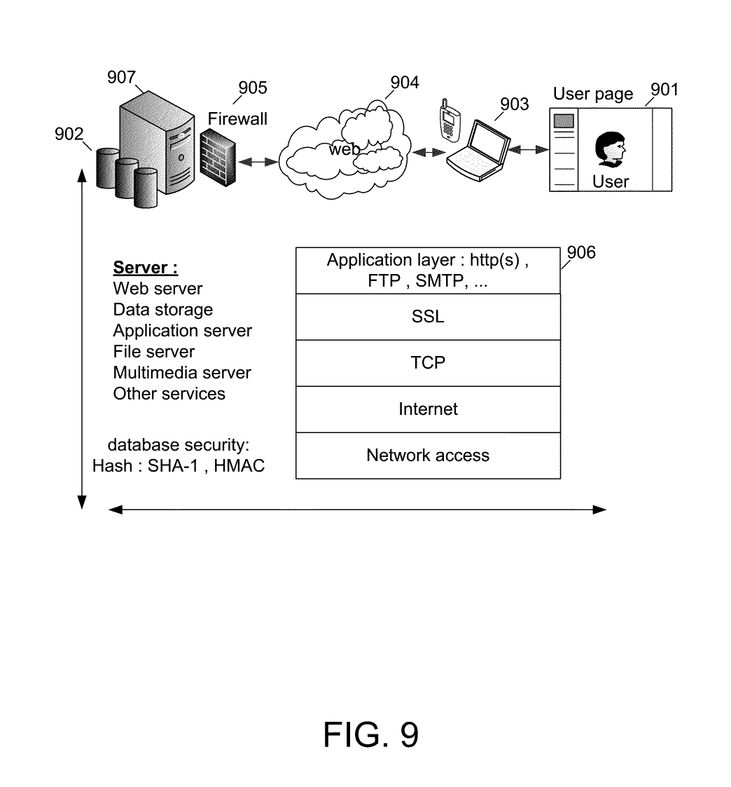

FIG. 9 is an illustrative system including a security solution for the method and system for educational networking and services of FIGS. 1-8. In FIG. 9, the system can include a security solution having a set of services to fulfill high level security objectives, including Confidentiality, Integrity and Availability (CIA). The communication path between the various users can be divided into server side components, web connection components 904, and user side components, such as user devices 903, and user pages 901.

Although there are many different security considerations and depending on the nature of the service, various risks are addressed, including (1) security concerns on the server side, such as database attacks; brute force attacks, denial of service attacks; (2) security concerns on the user side, such as user impersonation, repudiation, man in the middle attack, reflection, meet in the middle attack, dictionary attack, and the like. The system can employ symmetric key and public key encryption systems and methods to use on both the server and client/user side, but in order to both benefit from a secure communication and simplicity in implementation, SSL/TSL protocols can be employed above the TCP layer, and which can address the above mentioned security concerns.

Accordingly, a security solution protocol stack 906 is provided. In order to secure the various databases 902, employed, for example, are a hash function and a symmetric key cryptographic system, and the like, to protect the data from being modified or stolen. In one implementation, a firewall 905 at both the server and user side is employed to protect the system from unintended access, and the like. Suitable access control (e.g., authorization and authentication) can be provided through public key infrastructure (PKI) by obtaining valid certificates from certificate authorities (CA), and the like. The privacy solution includes a set of services to provide privacy for system, services, users, and the like, wherein privacy can include the users' right to decide how much of their information (.e.g., directly or indirectly related to the user) can be disclosed to the public. The service that implements such privacy is called a privacy service and the service provides privacy settings, for example, including personal information, academic activities, other activities, such as connections, conversations and search, research materials of users, applications, and the like. In general, all the information that users either knowingly or unknowingly create or modify is subject to a privacy policy set by the users.

Accordingly, a web server 907 provides local/remote services pertaining to the web, internet, and the like, 904. Data storage 902 is used for storing, managing, and the like, the various employed data, databases, applications related to such data, and the like. An application server is a server and/or cluster of servers provided to implement, run, support, and the like, the various described applications. A file server is a server and/or cluster of servers provided to implement, run, support, and the like, the various files employed by the various users. A multimedia server is a server and/or clusters of servers provided to implement, run, support, and the like, various multimedia applications, software, hardware, and the like, for users and external entities connected thereto. The various interfaces shown with double headed arrows can support both wired and wireless communications, and the services, applications, and the like, can run on any suitable wired and/or wireless devices, and operating systems.

A video chat (e.g., video conferencing) service can be provided to allow users to manage video calls, and selectively choose the contacts to communicate with through video chat, and the like. The video stream traverses the web 904 to reach the destination (e.g., target user), but the connection request can be managed by the server 907, with the security, privacy, and the like, aspects of the users applied to the corresponding video streams. The quality of such video chat can be based on a user preference, a quality of the web connection, the local user bandwidth, and the like, and which can be adjusted automatically to an optimum bit rate, and the like.

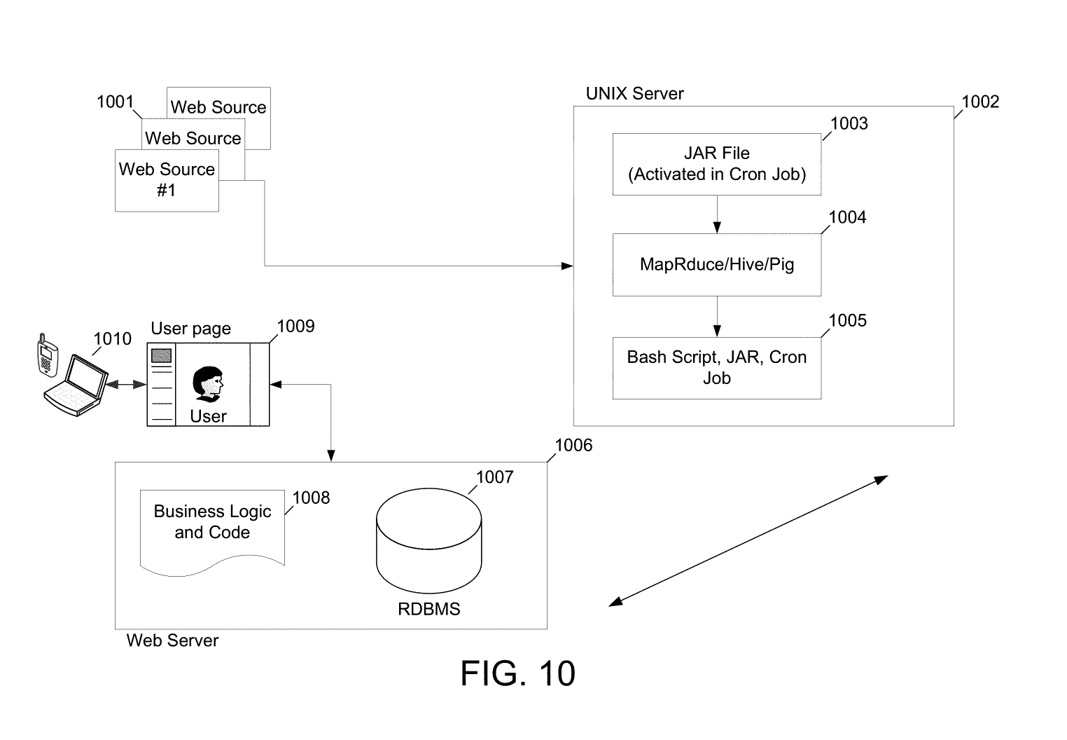

FIG. 10 explains the backend data processing system. Distributed web sources, 1001, are fed into a UNIX server box 1002. 1003 is a Java executable periodically triggered through UNIX cron job and preprocesses 1001. In 1004, Big Data techniques are implemented and used to process huge and unstructured data. 1005 is a post-processing stage that pushes data to RDBMS (1007) mainly in Oracle SQL and MySQL in 1006 which is a web application server. 1008 runs business logic to provide service to users such as 1009 and 1010.

Various services are provided, including a “My Documents” service by which users can create, edit, upload, download, store, share, generally manage, and the like, user documents, personal libraries, and the like. A “drag and drop” interface along with copy, cut and paste capabilities can be employed so that users can easily manage file transfers, and the like, among user folders and shared folders of connections, in addition to providing unlimited storage for users.

A “My Conferences” (e.g., conference and event management) service is provided so that users can create, edit, share, print, generally manage, and the like, a list of conferences, upcoming events, corresponding information, and the like.

The application processing service provides a unified application processing capability. Because of lack of visible and easy access information for applicants, most students end up applying to universities that they are not qualified for. However, with the present system and methods users can save on admission fees based on easy access to universities' criterion, minimum required degrees or documents, and the like. This service can interface between students and graduate schools, and the like, and undertake the processing of applications, including allowing students to sign up for and report test scores, such as TOEFL, GRE, GMAT, LSAT, and the like.

An email management service for professors provides an efficient email management tool. For example, the huge numbers of emails that are usually received from prospective students interested in coming to a University's Graduate School and/or joining a professor's research group can be inundating. When the professors are not looking for students or do not have an opening position, they do not reply to such emails until they want to hire a graduate student for their research. Advantageously, students can use the described system and methods to send such requests, get on a waiting list, and the like. Advantageously, whenever a professor needs to find a student for an opening position, the professor can go a prospective students list, and sort the students by any suitable criterion, and choose the best student, thus providing efficient communications between professors and students, and the like.

A digital/electronic signature for paperwork service is provided so as to avoid hand signing and scanning back of electronic documents, thus saving time and money. The service employs a secure, user friendly electronic signature for users, academic members, and the like, and for example, employing secure 128 bit encryption, and the like.

A global notice board service is provided to help professors post messages, notices, and the like, to the public and users of the system, and the like. This service gives professors the ability to share ideas, achievements, or any other news with the global academic/education community.

A visibility of research laboratories service is provided to improve the visibility of research laboratories, for example, where laboratories are searchable by industry recruiters for placement of jobs, and the like. For example, if a company needs to find a related laboratory for their business goal, they can search and find relevant laboratories and related information to help in making optimal business decisions, and the like. This service can be used to match industry needs with academic institutions (e.g., at Masters or Ph.D. graduate levels) for recruiting prospective employers, employees, and the like. A standard professors' laboratory webpage is provided by the system to address the problem of professors with low quality, and inefficient web pages, and solving updating problems as well, eliminating the need to hire a web designer/programmer to design and updated the pages for them. The service enables professors to add or remove any suitable information a standard automated format, and the like.

A unified recommendation letter issuance service provides a tool to unify recommendation letter issuance systems, and the like. For example, once a student gets connected to professors and/or other academic/educational contacts, the student can send a request to issue a recommendation letter. The recommendation letter issuer receives the request and can import the requester's profile information and even add other professors/entities to be copied as well. The recommendation letter can be signed digitally and automatically sent to corresponding parties, and the like. In addition, a copy of the recommendation can be sent to a requester upon consent of the receiving entity of recommendation letter.

A student tracking service is provided that enables professors to track all suitable aspects of an applicant's status. For example, a new issue in the US academic system, is that many graduate students leave their Ph.D. programs to work or transfer to better schools. With this service, administrators and faculty members can deal with such a problem easily by searching student names in the system to determine a student's status, resulting in less wastes of valuable resources and time for institutions, the federal government, faculties, and, of course, the students themselves, so as to track the users of the system in their educational pursuits, and the like.

A service is provided for managing current students and laboratories in terms of progress tracking, reporting, time sheets, MoM, appointment setting and group meetings, and the like.

A service is provided for school-industry relations that provides a portal for both schools and industry to communicate, and share news and updates, and the like.

A job fair and interview service is provided that enables industry to perform job interviews and job fairs using the unified system platform. Announcements, communication traffic, and the like, is routed through the system, including electronic advertisements, interactions, and the like.

A work force and placement service for industries, governments, and academic institutions enables users/entities is provided to generate a workforce for a project including announcements, hiring, and means for communicating with peers, team members, and the like.

An application fee processing service is provided that employs common E-commerce APIs to complete the application processing conducted with graduate schools, and the like. A score reporting service for prerequisite tests, such as GRE, GMAT, MCAT, LSAT, TOEFL, and the like, is included, greatly simplifying the application process for students, graduate schools, and the like.

Advantageously, the users of proposed network system and method can generate large amounts of social network traffic by getting millions of users together by staying connected to their peers, sharing educational material, creating admission profiles, and the like.

The above-described devices and subsystems of the illustrative embodiments can include, for example, any suitable servers, workstations, PCs, laptop computers, PDAs, Internet appliances, handheld devices, cellular telephones, wireless devices, other devices, and the like, capable of performing the processes of the illustrative embodiments. The devices and subsystems of the illustrative embodiments can communicate with each other using any suitable protocol and can be implemented using one or more programmed computer systems or devices.

One or more interface mechanisms can be used with the illustrative embodiments, including, for example, Internet access, telecommunications in any suitable form (e.g., voice, modem, and the like), wireless communications media, and the like. For example, employed communications networks or links can include one or more wireless communications networks, cellular communications networks, G3 communications networks, Public Switched Telephone Network (PSTNs), Packet Data Networks (PDNs), the Internet, intranets, a combination thereof, and the like.

It is to be understood that the devices and subsystems of the illustrative embodiments are for illustrative purposes, as many variations of the specific hardware used to implement the illustrative embodiments are possible, as can be appreciated by those skilled in the relevant art(s). For example, the functionality of one or more of the devices and subsystems of the illustrative embodiments can be implemented via one or more programmed computer systems or devices.

To implement such variations as well as other variations, a single computer system can be programmed to perform the special purpose functions of one or more of the devices and subsystems of the illustrative embodiments. On the other hand, two or more programmed computer systems or devices can be substituted for any one of the devices and subsystems of the illustrative embodiments. Accordingly, principles and advantages of distributed processing, such as redundancy, replication, and the like, also can be implemented, as desired, to increase the robustness and performance of the devices and subsystems of the illustrative embodiments.

FIG. 10 is an illustrative backend data processing system that generates a major part of data sources for educational and academic networking services and users consumption. In 1003, multiple JAR files are triggered through crop jon located in a crontab file in UNIX box. These jobs run every day:

59 23 * * * /home/EduDemia/bin/script1.sh>

/home/EduDemia/logs/script1.out 2>&1 /home/EduDemia/logs/script1.err

Script1.sh provides the unstructured data from distributed sources in 1001. Inside script.sh, there is JAR file that collects the data from 1001. The output of this part is a big file with unstructured data, datafile1.txt. The Map-Reduce code below processes datafile1.txt:

| | |
|---|---|
| 1. | package org.edudemia; |
| 2. | |
| 3. | import java.io.IOException; |
| 4. | import java.util.*; |
| 5. | |
| 6. | import org.apache.hadoop.fs.Path; |
| 7. | import org.apache.hadoop.conf.*; |
| 8. | import org.apache.hadoop.io.*; |
| 9. | import org.apache.hadoop.mapred.*; |
| 10. | import org.apache.hadoop.util.*; |
| 11. | |
| 12. | public class EduDemia { |
| 13. | |
| 14. | public static class Map extends MapReduceBase implements |

Mapper<LongWritable, Text, Text, IntWritable> {

| | |
|---|---|
| 15. | private final static IntWritable one = new IntWritable(1); |
| 16. | private Text word = new Text( ); |
| 17. | |
| 18. | public void map(LongWritable key, Text value, |

OutputCollector<Text, IntWritable> output, Reporter reporter) throws
IOException {

| | |
|---|---|
| 19. | String line = value.toString( ); |
| 20. | StringTokenizer tokenizer = new StringTokenizer(line); |
| 21. | while (tokenizer.hasMoreTokens( )) { |
| 22. | word.set(tokenizer.nextToken( )); |
| 23. | output.collect(word, one); |
| 24. | } |
| 25. | } |
| 26. | } |
| 27. | |
| 28. | public static class Reduce extends MapReduceBase implements |

Reducer<Text, IntWritable, Text, IntWritable> {

| | |
|---|---|
| 29. | public void reduce(Text key, Iterator<IntWritable> values, |

OutputCollector<Text, IntWritable> output, Reporter reporter) throws
IOException {

| | |
|---|---|
| 30. | int sum = 0; |
| 31. | while (values.hasNext( )) { |
| 32. | sum += values.next( ).get( ); |
| 33. | } |
| 34. | output.collect(key, new IntWritable(sum)); |
| 35. | } |
| 36. | } |
| 37. | |
| 38. | public static void main(String[ ] args) throws Exception { |
| 39. | JobConf conf = new JobConf(EduDemia.class); |
| 40. | conf setJobName(“wordcount”); |
| 41. | |
| 42. | confsetOutputKeyClass(Text.class); |
| 43. | confsetOutputValueClass(IntWritable.class); |
| 44. | |
| 45. | confsetMapperClass(Map.class); |
| 46. | confsetCombinerClass(Reduce.class); |
| 47. | confsetReducerClass(Reduce.class); |
| 48. | |
| 49. | confsetInputFormat(TextInputFormat.class); |
| 50. | conf setOutputFormat(TextOutputFormat.class); |
| 51. | |
| 52. | FileInputFormat.setInputPaths(conf, new Path(args[0])); |
| 53. | FileOutputFormat.setOutputPath(conf, new Path(args[1])); |
| 54. | |
| 55. | JobClient.runJob(conf); |
| 57. | } |
| 58. | } |

In FIG. 10, 1004, assuming HADOOP_HOME is the root of the installation and HADOOP_VERSION is the Hadoop version installed, we compile EduDemia.java and create a JAR file:
$ javac—classpath $ {HADOOP_HOME}/hadoop-$ {HADOOP_VERSION}—
core.jar—d edudemia_classes WordCount.java
$ jar—cvf/usr/edudemia/edujar1.jar—C edudemia_classes/.
   The HDFS locations for input and output are:

/usr/edudemia/datamining/input/datafile1.txt—input directory in HDFS

/usr/edudemia/datamining/output/outfile1.txt—output directory in HDFS

The application (JAR) is run then:
$ bin/hadoop jar /usr/edudemia/edujar1.jar org.edudemia.EduDemia
/usr/edudemia/datamining/input /usr/edudemia/datamining/output
The results are:
$ bin/hadoop dfs—cat/usr/edudemia/datamining/output/part-00000

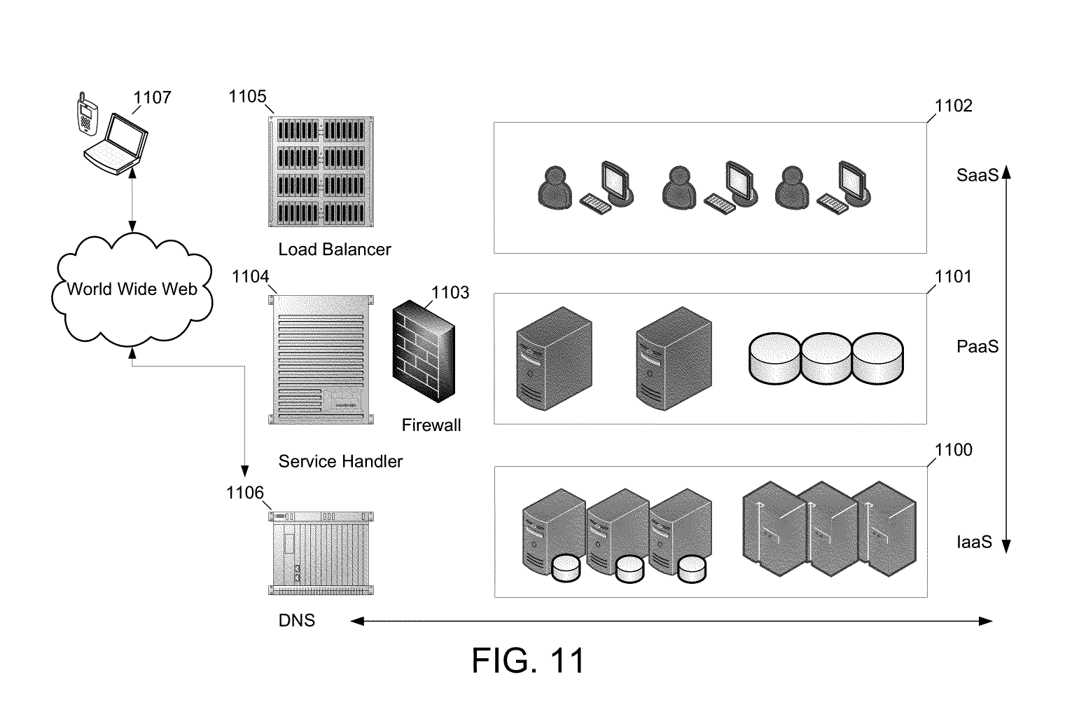

FIG. 11 is an illustrative cloud infrastructure that enables the educational and academic networking to benefit from elasticity, scalability, affordability, and reliability provided buy cloud. Three layers of service provided by cloud are as 1100, 1101, 1102—IaaS (Infrastructure as a Service) and PaaS (Platform as a Service), respectively. The educational and academic networking services currently operates exploiting PaaS and IaaS. The user traffic coming from 1107 goes through 1106, which is a DNS server. 1104 and 1105 are service handler and load balancer respectively. 1105 balances the load and distributes it according to current load on each network component in above mentioned layers. 1105 not only distributes the load amongst network elements and cloud resources, but also consistently and constantly refreshes the meta data about node availability/failure. Load balancing is done in both software and hardware. The hardware part of 1105 is a traditional 1 load balancer that monitors the ports and measures the traffic in order to keep the traffic at a balanced level. The software part of 1105, sits one layer above hardware layer and is more flexible measuring the traffic and distributing it amongst network resource. Different load balancing algorithm and fault tolerance methods are able to be implemented while assisting with Quality of Service policies. 1104 is Service Handle which processes requests and threads in coordination with message queue APIs such as Active Message Queue (AMQ). The processing power resides in 1100 and Oracle/MySQL reside in 1101.

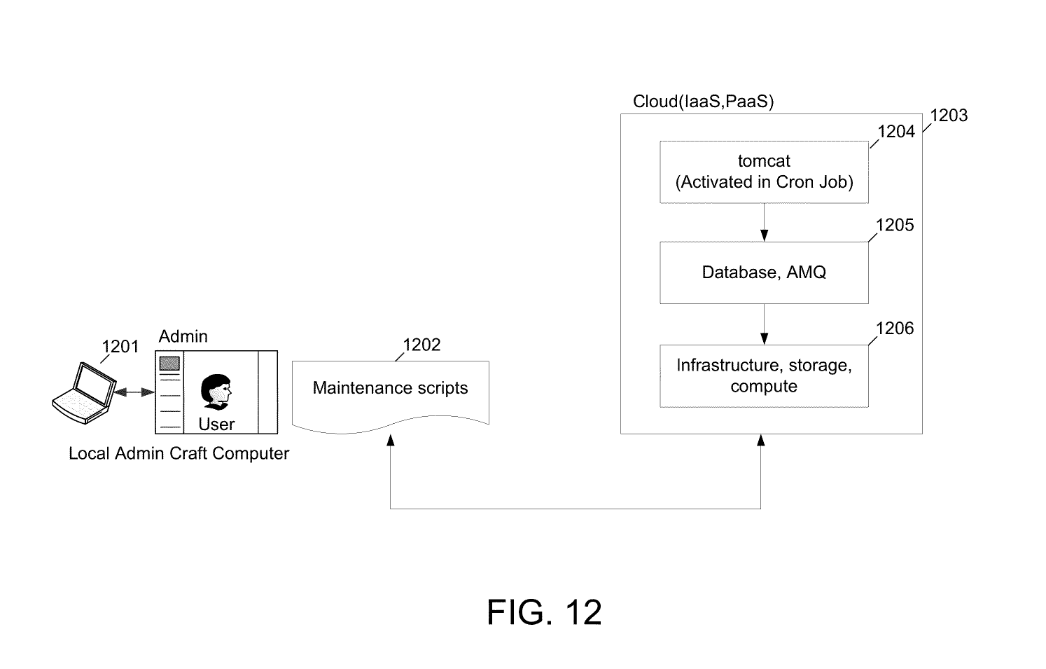

FIG. 12 is an illustrative cloud infrastructure that enables the educational and academic networking to periodically monitor and maintain the database. The network admin launches maintenance script through 1201. This script is run on platform part of cloud and checks for connectivity, availability and sanity of data in data storage in 1205. The errors and logs are then notified through AMQ and the results of monitoring the database is fed back to admin craft computer. Finally, maintenance person can look at results and make decisions, accordingly.

In one example, the system provides visa information for students, or travel information for students, as one package, in coordination of other services.

The devices and subsystems of the illustrative embodiments can store information relating to various processes described herein. This information can be stored in one or more memories, such as a hard disk, optical disk, magneto-optical disk, RAM, and the like, of the devices and subsystems of the illustrative embodiments. One or more databases of the devices and subsystems of the illustrative embodiments can store the information used to implement the illustrative embodiments of the present inventions. The databases can be organized using data structures (e.g., records, tables, arrays, fields, graphs, trees, lists, and the like) included in one or more memories or storage devices listed herein. The processes described with respect to the illustrative embodiments can include appropriate data structures for storing data collected and/or generated by the processes of the devices and subsystems of the illustrative embodiments in one or more databases thereof.

All or a portion of the devices and subsystems of the illustrative embodiments can be conveniently implemented using one or more general purpose computer systems, microprocessors, digital signal processors, micro-controllers, and the like, programmed according to the teachings of the illustrative embodiments of the present inventions, as can be appreciated by those skilled in the computer and software arts. Appropriate software can be readily prepared by programmers of ordinary skill based on the teachings of the illustrative embodiments, as can be appreciated by those skilled in the software art. Further, the devices and subsystems of the illustrative embodiments can be implemented on the World Wide Web. In addition, the devices and subsystems of the illustrative embodiments can be implemented by the preparation of application-specific integrated circuits or by interconnecting an appropriate network of conventional component circuits, as can be appreciated by those skilled in the electrical art(s). Thus, the illustrative embodiments are not limited to any specific combination of hardware circuitry and/or software.

Stored on any one or on a combination of computer readable media, the illustrative embodiments of the present inventions can include software for controlling the devices and subsystems of the illustrative embodiments, for driving the devices and subsystems of the illustrative embodiments, for enabling the devices and subsystems of the illustrative embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the illustrative embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the illustrative embodiments of the present inventions can be distributed for better performance, reliability, cost, and the like.

As stated above, the devices and subsystems of the illustrative embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present inventions have been described in connection with a number of illustrative embodiments, and implementations, the present inventions are not so limited, but rather cover various modifications, and equivalent arrangements, which fall within the purview of the appended claims.

1. A computer implemented system for educational networking, the system comprising:
a computer server coupled to a communications network;
the computer server configured to provide educational networking and services to users on client devices coupled to the computer server over the communications network;
the educational networking and services configured for automating application generation and processing at educational schools for the users on the client devices;
the educational networking and services configured for searching and displaying on the client devices professors at the schools, schools to apply to, funding resources for attending the schools, and laboratories at the schools; and
the educational networking and services configured for creating and displaying on the client devices school application portfolios, modifying school application portfolios, and generating and processing applications to selected schools.

2. The system of claim 1, further comprising:
the educational networking and services configured for searching and displaying on the client devices professors and advisors at selected schools; and
the educational networking and services configured for communicating and networking with professors and advisors at selected schools on the client devices, maintaining and displaying on the client devices records regarding potential schools, and determining and displaying on the client devices probabilities of admission of the users at selected schools.

3. The system of claim 1, further comprising:
the educational networking and services configured for creating and displaying on the client devices standardized profile pages for the users.

4. The system of claim 3, further comprising:
the educational networking and services configured for creating and displaying on the client devices standardized resumes based on the standardized profile pages, editing the generated resumes, and tracking revisions in the generated resumes.

5. The system of claim 1, further comprising:
the educational networking and services configured for providing social networking services including creating and displaying on the client devices social networks and related services for the users.

6. The system of claim 1, further comprising:
the educational networking and services configured for generating, streaming via a global RSS feed and displaying on the client devices academic and educational related news and updates;
the educational networking and services configured for determining, processing and displaying on the client devices open businesses and government positions for the users; and
the educational networking and services configured for determining, processing and displaying on the client devices projects and taskforces for businesses and government projects to be serviced by the users.

7. A computer implemented method for a system for educational networking, the method comprising:
providing by computer server coupled to a communications network educational networking and services to users on client devices coupled to the computer server over the communications network;
automating by the server via the educational networking and services application generation and processing at educational schools for the users on the client devices;
searching and displaying on the client devices by the server via the educational networking and services professors at the schools, schools to apply to, funding resources for attending the schools, and laboratories at the schools; and
displaying on the client devices school application portfolios, modifying school application portfolios, and generating and processing applications to selected schools by the server via the educational networking and services.

8. The method of claim 7, further comprising:
searching and displaying on the client devices by the server via the educational networking and services professors and advisors at selected schools; and
communicating and networking with professors and advisors at selected schools on the client devices, maintaining and displaying on the client devices records regarding potential schools, and determining and displaying on the client devices probabilities of admission of the users at selected schools by the server via the educational networking and services.

9. The method of claim 7, further comprising:
creating and displaying on the client devices by the server via the educational networking and services standardized profile pages for the users.

10. The method of claim 9, further comprising:
creating and displaying on the client devices standardized resumes based on the standardized profile pages, editing the generated resumes, and tracking revisions in the generated resumes by the server via the educational networking and services.

11. The method of claim 7, further comprising:
providing social networking services including creating and displaying on the client devices social networks and related services for the users by the server via the educational networking and services.

12. The method of claim 7, further comprising:
generating, streaming via a global RSS feed and displaying on the client devices academic and educational related news and updates by the server via the educational networking and services;
determining, processing and displaying on the client devices open businesses and government positions for the users by the server via the educational networking and services; and
determining, processing and displaying on the client devices projects and taskforces for businesses and government projects to be serviced by the users by the server via the educational networking and services.

13. A computer program product for system for educational networking, and including one or more computer readable instructions embedded on a tangible, non-transitory computer readable medium and configured to cause one or more computer processors to perform the steps of:
providing by computer server coupled to a communications network educational networking and services to users on client devices coupled to the computer server over the communications network;
automating by the server via the educational networking and services application generation and processing at educational schools for the users on the client devices;
searching and displaying on the client devices by the server via the educational networking and services professors at the schools, schools to apply to, funding resources for attending the schools, and laboratories at the schools; and
displaying on the client devices school application portfolios, modifying school application portfolios, and generating and processing applications to selected schools by the server via the educational networking and services.

14. The computer program product of claim 13, further comprising:
searching and displaying on the client devices by the server via the educational networking and services professors and advisors at selected schools; and
communicating and networking with professors and advisors at selected schools on the client devices, maintaining and displaying on the client devices records regarding potential schools, and determining and displaying on the client devices probabilities of admission of the users at selected schools by the server via the educational networking and services.

15. The computer program product of claim 13, further comprising:
creating and displaying on the client devices by the server via the educational networking and services standardized profile pages for the users.

16. The computer program product of claim 14, further comprising:
creating and displaying on the client devices standardized resumes based on the standardized profile pages, editing the generated resumes, and tracking revisions in the generated resumes by the server via the educational networking and services.

17. The computer program product of claim 13, further comprising:
providing social networking services including creating and displaying on the client devices social networks and related services for the users by the server via the educational networking and services.

18. The computer program product of claim 13, further comprising:
generating, streaming via a global RSS feed and displaying on the client devices academic and educational related news and updates by the server via the educational networking and services;
determining, processing and displaying on the client devices open businesses and government positions for the users by the server via the educational networking and services; and
determining, processing and displaying on the client devices projects and taskforces for businesses and government projects to be serviced by the users by the server via the educational networking and services.

19. The computer program product of claim 13, further comprising:
providing visa information for students.

20. The computer program product of claim 13, further comprising:
providing travel information for students.
